(19) United States
(12) Patent Application Publication
(10) Pub. No.: US 2018/0087698 A1
(43) Pub. Date: Mar. 29, 2018

(54) BAND CLAMP FOR OVERLAPPING PIPE ENDS

(71) Applicant: Norma U.S. Holding LLC, Auburn Hills, MI (US)

(72) Inventors: Andrew Lenn, Fraser, MI (US); Brian T. Geese, Lake Orion, MI (US); Brian T. Ignaczak, Rochester, MI (US); Shuokai Chang, Irvine, CA (US)

(21) Appl. No.: 15/715,978

(22) Filed: Sep. 26, 2017

Related U.S. Application Data
(60) Provisional application No. 62/399,644, filed on Sep. 26, 2016.

(51) Int. Cl. F16L 21/06

(52) U.S. Cl. CPC F16L 21/065

(57) ABSTRACT

A band clamp is employed to secure an overlapping pipe end configuration involving a female pipe end and a male pipe end. The band clamp includes a band and a tightening mechanism. The band has a pair of flanges, each made up of inboard and outboard layers with a closed loop spanning at distal ends therebetween. The tightening mechanism includes a single bolt and a single nut. Stiffness is imparted to one or both of the flanges via a washer, one or more ribs, and/or one or more embossments.

### CROSS-REFERENCE TO RELATED APPLICATION

This application claims the benefit of U.S. Provisional Patent Application No. 62/399,644, filed Sep. 26, 2016, the entire contents of which are hereby incorporated by reference.

### TECHNICAL FIELD

This disclosure relates generally to pipe clamps used to secure pipes together, and, more particularly, to band clamps to secure pipe ends in an overlapping configuration.

### BACKGROUND

Pipe clamps are used to secure pipe ends together. Pipe clamps are commonly equipped in automotive exhaust pipe applications, as well as in other applications. To be effective, a joint established between the pipe ends should provide a fluid-tight seal against leakage and should have good joint retention. One type of pipe clamp is a band clamp. Band clamps are designed and constructed for use with telescopically overlapping pipe end configurations. Some band clamps are provided with a tightening mechanism that includes a reaction member and other components to assist in its tightening action. For instance, U.S. Pat. No. 6,269,524 discloses a reaction member (42). Still, other pipe clamps lack reaction members and instead employ other measures to assist the tightening action. For instance, U.S. Pat. No. 7,475,919 discloses flanges (24, 26) with loops (28, 30) and a tightening mechanism (36) having a pair of bolts (64) and a pair of nuts (70). The '919 patent also discloses a split sealing sleeve (12). Pairs of bolts and nuts and split sealing sleeves are conventional in pipe couplers meant for end-to-end abutting pipe end configurations.

### SUMMARY

In an embodiment, a band clamp designed and constructed for securing overlapping pipe ends may include a band and a tightening mechanism. The band spans circumferentially from a first end to a second end. The band has a first flange that extends in a radial direction away from the first end, and has a second flange that extends in a radial direction away from the second end. The first flange has a first inboard layer and a first outboard layer. The first inboard and outboard layers make surface-to-surface abutment. The first flange has a first closed loop at distal ends of the first inboard and outboard layers. The first flange has a first aperture that resides in the first inboard and outboard layers at the surface-to-surface abutment between those two layers. The second flange has a second inboard layer and a second outboard layer. The second inboard and outboard layers make surface-to-surface abutment. The second flange has a second closed loop at distal ends of the second inboard and outboard layers. The second flange has a second aperture that resides in the second inboard and outboard layers at the surface-to-surface abutment between those two layers. The tightening mechanism is used to tighten and loosen the band clamp over the overlapping pipe ends. The tightening mechanism includes a single bolt, a single nut, and a washer. The single bolt has a head and a shank. The head engages the first flange. The shank is disposed through the first and second apertures and is partly or more threaded. The single nut is carried by the shank. And the washer is carried by the shank between the single nut and the second flange. The washer engages the second flange. Amid tightening of the band clamp over the overlapping pipe ends, the single nut is rundown on the single bolt and the first and second flanges are brought toward each other. The first and second closed loops initially make contact between the first and second flanges, and the contact in part causes the first and second ends of the band to be drawn toward each other. Furthermore, engagement between the bolt's head and the first flange effects a first bow-shaped deformation in the first flange at the surface-to-surface abutment between the first inboard and outboard layers. And engagement between the washer and the second flange effects a second bow-shaped deformation in the second flange at the surface-to-surface abutment between the second inboard and outboard layers.

In another embodiment, a band clamp designed and constructed for securing overlapping pipe ends may include a band, a tightening mechanism, and a stiffening means. The band spans circumferentially from a first end to a second end. The band has a first flange that extends in a radial direction away from the first end, and has a second flange that extends in a radial direction away from the second end. The first flange has a first inboard layer and a first outboard layer. The first inboard and outboard layers make surface-to-surface abutment. The first flange has a first closed loop at distal ends of the first inboard and outboard layers. The first flange has a first aperture that resides in the first inboard and outboard layers at the surface-to-surface abutment between those two layers. The second flange has a second inboard layer and a second outboard layer. The second inboard and outboard layers make surface-to-surface abutment. The second flange has a second closed loop at distal ends of the second inboard and outboard layers. The second flange has a second aperture that resides in the second inboard and outboard layers at the surface-to-surface abutment between those two layers. The tightening mechanism is used to tighten and loosen the band clamp over the overlapping pipe ends. The tightening mechanism includes a single bolt and a single nut. The single bolt is disposed in the first and second apertures of the first and second flanges. The stiffening means may be applied to the first flange, may be applied to the second flange, or may be applied to both of the first and second flanges. The stiffening means, when applied, imparts stiffness to the respective flange(s). Amid initial rundown of the single nut on the single bolt, the first and second flanges are brought toward each other. The first and second ends of the band are, in turn, drawn toward each other to close a gap defined between the band's first and second ends. The gap is closed by a first distance. Upon further rundown of the single nut on the single bolt, the first and second closed loops make contact. The first flange deforms into a first bow-shape and the second flange deforms into a second bow-shape. The first and second ends of the band are, in turn, drawn toward each other to close the gap defined therebetween by a second distance. Meanwhile, the stiffening means facilitates the closings of the gap by the first distance and by the second distance amid the respective rundowns.

It is envisaged that the various aspects, embodiments, examples, features, and alternatives set forth in the preceding paragraphs, in the claims, in the detailed description, and/or in the figures, may be taken independently and individually or in any combination thereof.

### BRIEF DESCRIPTION OF THE DRAWINGS

Embodiments of the disclosure will hereinafter be described in conjunction with the appended drawings, wherein like designations denote like elements, and wherein:

FIG. 1 is a perspective view of an embodiment of a pipe lap joint with a band clamp and a female pipe end and a male pipe end;

FIG. 2 is another perspective view of the pipe lap joint of FIG. 1;

FIG. 3 is a side view of an embodiment of a female pipe;

FIG. 4 is an end view of the pipe lap joint of FIG. 1;

FIG. 5 is an enlarged view from one side of an embodiment of flanges of the band clamp of FIG. 1;

FIG. 6 is an enlarged view from another side of the flanges of FIG. 5;

FIG. 7 is an enlarged view from one side of an embodiment of a tightening mechanism of the band clamp of FIG. 1;

FIG. 8 is an enlarged view from another side of the tightening mechanism of

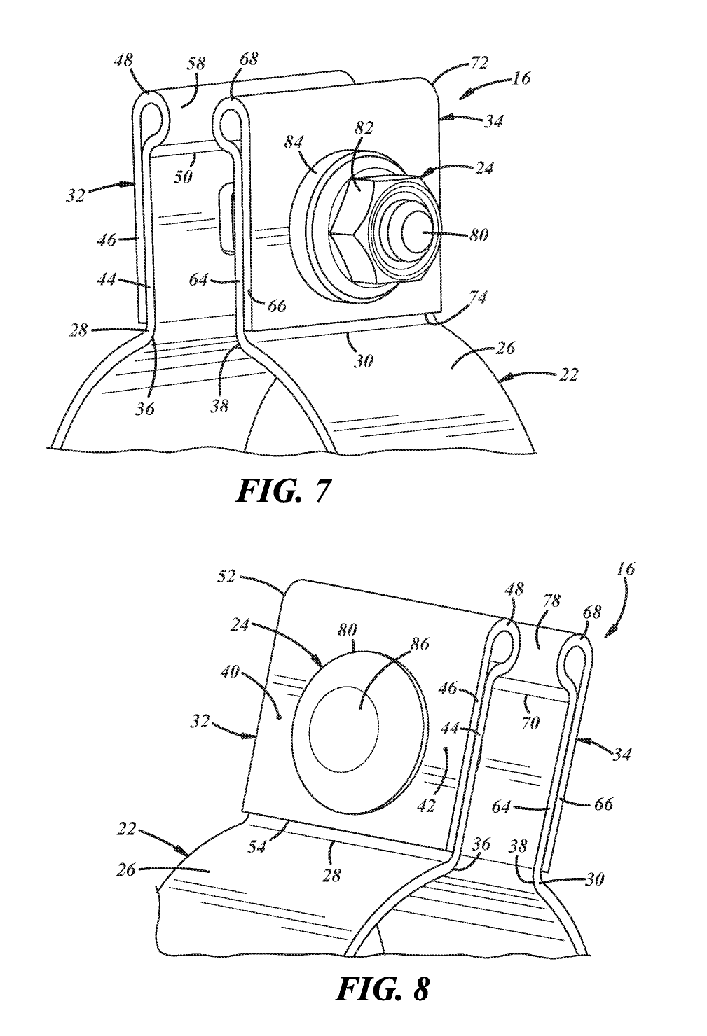

FIG. 7;

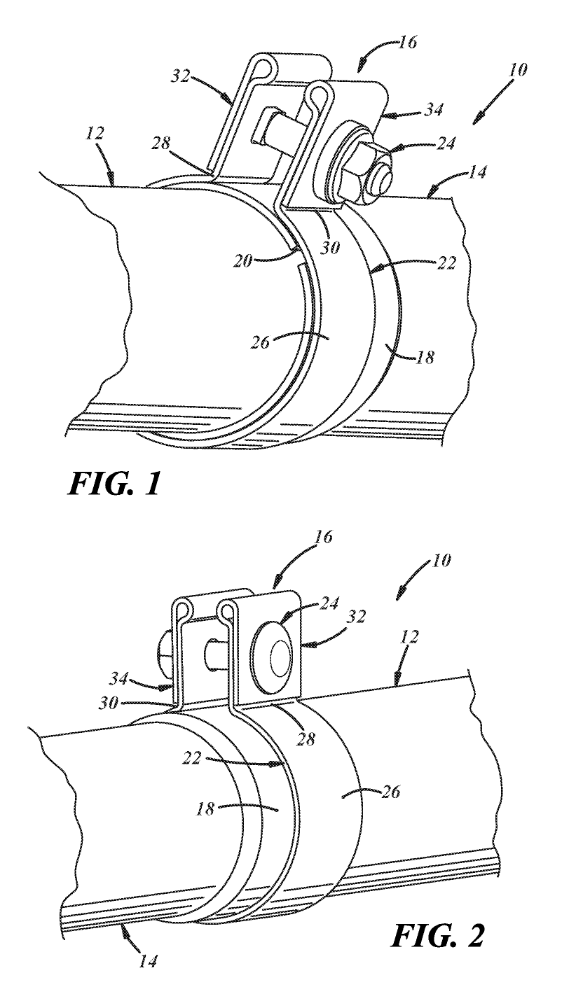

FIG. 9 is an end view of the band clamp of FIG. 1;

FIG. 10 is an end view of the pipe lap joint of FIG. 1;

FIG. 11 is an end view of another embodiment of a pipe lap joint with a band clamp and a female pipe end and a male pipe end;

FIG. 12 is an end view of another embodiment of a band clamp that can be used with a pipe lap joint; and

FIG. 13 is a side view of the band clamp of FIG. 12.

### DETAILED DESCRIPTION

Referring to the drawings, several embodiments of a band clamp are disclosed that are intended to secure pipe ends in a telescopically overlapping configuration. The band clamps exhibit an efficient design and construction with, in some instances, four or fewer components, while still providing an effective fluid-tight seal at a joint established between the pipe ends and an effective joint retention thereat. The band clamps are lightweight and, due in part to the minimized component count, are more readily assembled and installed and serviced in application compared to clamps with a greater number of components. To help ensure proper joint establishment and retention, stiffness is imparted to one or both flanges of the band clamps. The band clamps are suitable for use with automotive exhaust pipes and with pipes in other applications including aircraft pipes, marine pipes, and industrial equipment pipes, to cite a few examples. Furthermore, unless otherwise specified, the terms radially, axially, circumferentially, and their grammatical variations refer to directions with respect to the generally circular and cylindrical shapes of the band clamps and pipe ends depicted in the figures; and the term angularly and its grammatical variations refer to locations at points around the circumferences of the generally circular and cylindrical shapes of the band clamps and pipe ends depicted in the figures.

Referring to FIGS. 1-3, an embodiment of a pipe lap joint 10 includes a male pipe end 12, a female pipe end 14, and a band clamp 16. The male and female pipe ends 12, 14 are composed of a metal material in this example. When brought together in assembly and installation, the male pipe end 12 is inserted into a larger diameter section 18 of the female pipe end 14. The larger diameter section 18 telescopically receives the smaller diameter male pipe end 12 in an overlapping arrangement with the female pipe end 14 residing outside of the inside-residing male pipe end 12. The male pipe end 12 can be inserted into the female pipe end 14 to an axial depth of overlapping insertion between the two pipe ends that is greater than an axial extent of the band clamp 16, for example. The band clamp 16 is situated around the female pipe end 14, as demonstrated in FIGS. 1 and 2, and over the axial depth of overlapping insertion between the male and female pipe ends 12, 14. The band clamp 16 could be pre-attached to an outside surface of the female pipe end 14 such as by spot welds.

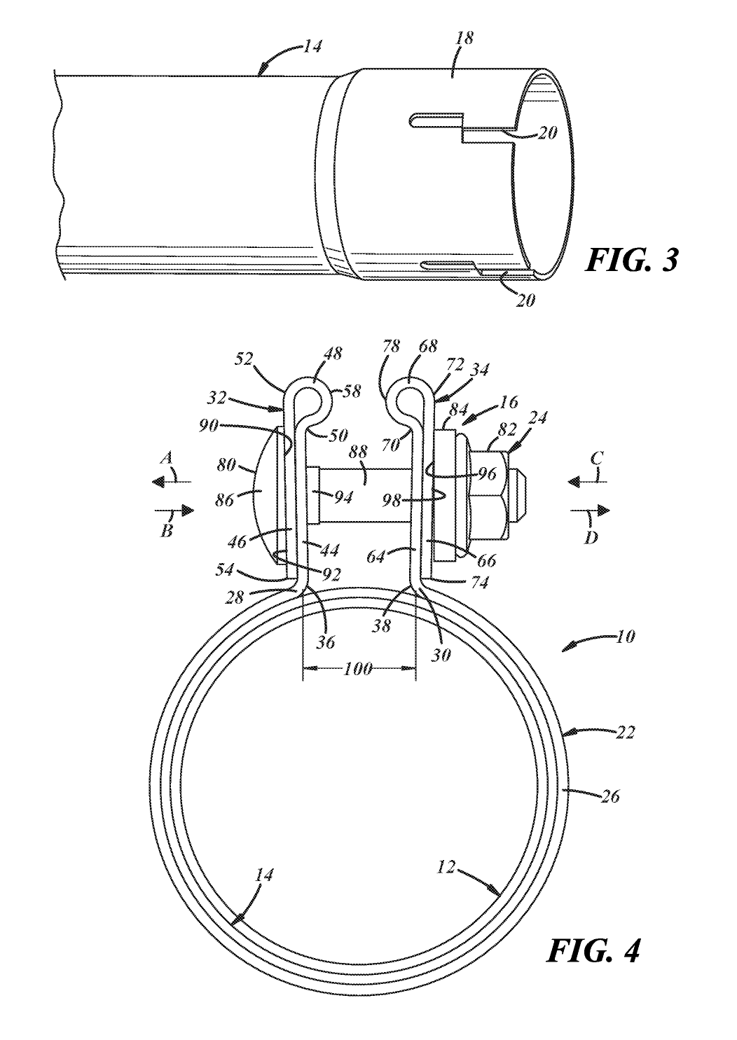

Referring particularly to FIG. 3, the female pipe end 14 can have one or more collapsible sealing slots 20 defined in a terminal free end of the female pipe end 14. Example collapsible sealing slots that could be suitable are taught in U.S. Pat. Nos. 5,588,680; 6,089,624; 6,199,921; and 7,246,826, all of the entire contents of which are hereby incorporated by reference. When present in one example, the collapsible sealing slots 20 are spaced angularly from a tightening mechanism (subsequently described) of the band clamp 16 and away from a gap thereat, with a first collapsible sealing slot located approximately forty-five degrees (45°) to one side of the tightening mechanism and a second collapsible sealing slot located approximately forty-five degrees (45°) to the other side of the tightening mechanism. Of course, other example locations are possible. The collapsible sealing slots 20 have been shown to preclude an unfavorable condition in which the female pipe end 14 deforms upon rundown in a pucker-like manner at the gap of the tightening mechanism, increasing the possibility of fluid leakage in the pipe lap joint 10.

Referring now to FIGS. 1, 2, and 4, this embodiment of the band clamp 16 includes a band 22 and a tightening mechanism 24. The band 22 is placed around the female pipe end 14 adjacent the terminal free end of the female pipe end 14 and tightened down thereon during rundown of the tightening mechanism 24. The band 22 can be made from a rolled sheet of metal material, such as stainless steel or another metal, and can be formed into its final shape via a suitable metalworking process. In some examples, the band 22 can be of a thinner gauge sheet of metal with a radial thickness of approximately 1.5 millimeters (mm); of course, other thickness dimensions are possible. The band 22 has a body 26 with a circumferential extent spanning between a first end 28 and a second end 30.

In the embodiment presented in the figures, the band 22 has a first flange 32 extending generally radially from the first end 28 and has a second flange 34 extending generally radially from the second end 30. The first and second flanges 32, 34 cooperate with the tightening mechanism 24 and serve as the band's connection to the tightening mechanism 24, and strengthen that site of cooperation and connection. Because the first and second flanges 32, 34 cooperate with a single tightening mechanism having a single bolt and single nut, the first and second flanges 32, 34 have an axial extent fitted for the single tightening mechanism. The first and second flanges 32, 34 are unitary extensions of the body 26 of the band 22 and hence are made from the same sheet of metal material. The transitions between the body 26 and the first and second flanges 32, 34 are made via somewhat sudden first and second bends 36, 38 formed in the sheet of metal material. The sheet of metal material transforms from a rounded conformation at the body 26 to a planar conformation at the first and second flanges 32, 34 by way of the first and second bends 36, 38. As demonstrated in the figures, the first and second flanges 32, 34 are mirror images of each other, with the exception of bolt aperatures.

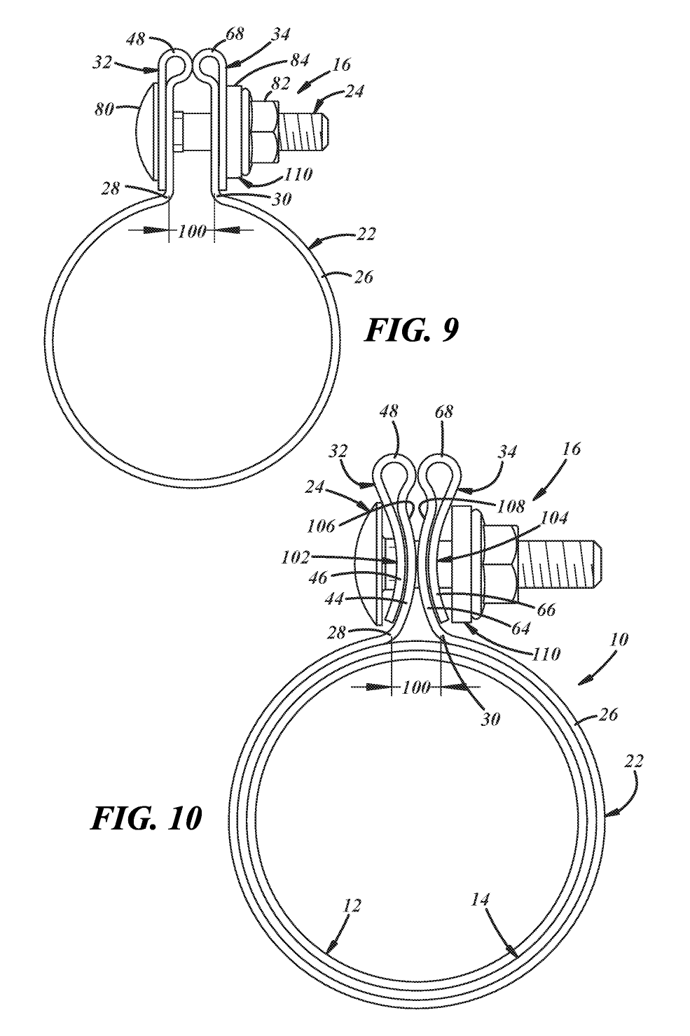

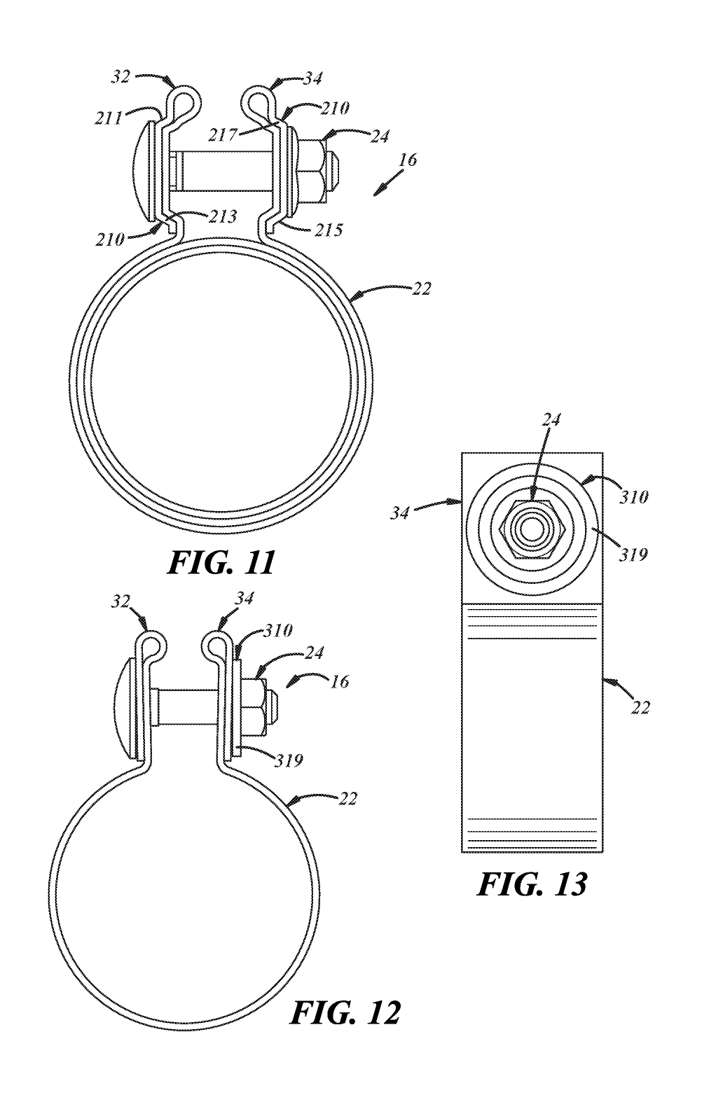

Referring now to FIGS. 4-8, the first flange 32 is made by folding and wrapping the sheet of metal material back onto itself in an outboard direction A. The resulting layered sheets of metal material are strengthened relative to the single-layer body 26. The folded sheets of metal material can be attached together at a first point of attachment 40, at a second point of attachment 42, or at both points of attachment, as examples (FIG. 8). The attachment(s) can be carried out via spot-welding, riveting, or another attachment technique. The first flange 32 has a first inboard layer 44, a first outboard layer 46, and a first closed loop 48. The first inboard and outboard layers 44, 46 make surface-to-surface abutment at their respective confronting inner surfaces. The first inboard layer 44 has a planar conformation. The first inboard layer 44 spans immediately from the first end 28 and from the first bend 36, and extends radially outwardly therefrom to an inboard distal end 50 where the sheet of metal material transitions to the first closed loop 48. The first outboard layer 46 has a planar conformation. The first outboard layer 46 spans immediately from the first closed loop 48 at an outboard distal end 52, and terminates at a proximal end 54 which is a terminal free end of the first outboard layer 46. Compared to the first inboard layer 44, the first outboard layer 46 has a greater radial length and extent.

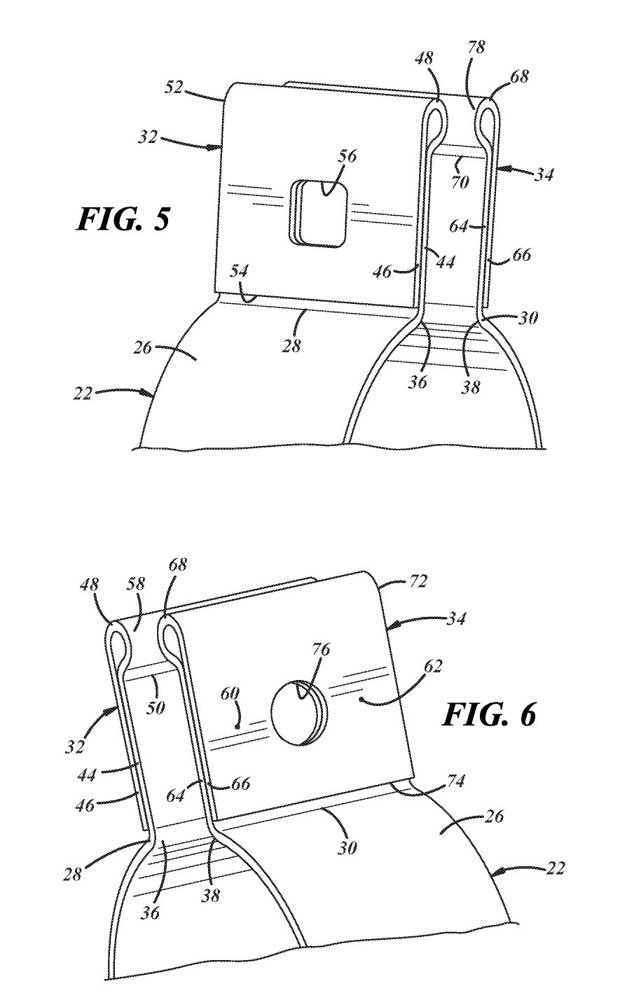

A first aperture 56 is defined in the first flange 32 and through the first inboard and outboard layers 44, 46. The first aperture 56 receives insertion of a bolt (subsequently described) of the tightening mechanism 24. As perhaps shown best in FIG. 5, the first aperture 56 can have a non-circular shape such as a square or rectangular shape. The non-circular shape of the first aperture 56, when provided, matches a non-circular shape of a section of the bolt that is inserted in the first aperture 56. When fitted together, the non-circular shapes preclude the bolt from spinning concurrently with a nut (subsequently described) of the tightening mechanism 24 during rundown of the tightening mechanism 24. In other embodiments, the first aperture 56 need not have a non-circular shape and instead could have a circular shape. The first closed loop 48 is situated at the distal ends 50, 52 of the first inboard and outboard layers 44, 46, and is defined at the vertex of the folded sheet of metal material. The first closed loop 48 resides inboard with respect to the first inboard and outboard layers 44, 46. An inboard-directed surface 58 of the first closed loop 48 constitutes the most inboardly-directed section of the first flange 32 relative to its other sections—in other words, a bight in the loop of the first closed loop 48 faces inwardly.

Still, in other embodiments not presented in the figures, the first flange 32 could have other designs and constructions. For instance, the first flange 32 could be made by folding the sheet of metal material back onto itself in an inboard direction B.

Maintaining reference to FIGS. 4-8, the second flange 34 is made by folding and wrapping the sheet of metal material back onto itself in an outboard direction C (outboard direction C is defined with respect to the second flange 34). The resulting layered sheets of metal material are strengthened relative to the single-layer body 26. The folded sheets of metal material can be attached together at a first point of attachment 60, at a second point of attachment 62, or at both points of attachment, as examples (FIG. 6). The attachment(s) can be carried out via spot-welding, riveting, or another attachment technique. The second flange 34 has a second inboard layer 64, a second outboard layer 66, and a second closed loop 68. The second inboard and outboard layers 64, 66 make surface-to-surface abutment at their respective confronting inner surfaces. The second inboard layer 64 has a planar conformation. The second inboard layer 64 spans immediately from the second end 30 and from the second bend 38, and extends radially outwardly therefrom to an inboard distal end 70 where the sheet of metal material transitions to the second closed loop 68. The second outboard layer 66 has a planar conformation. The second outboard layer 66 spans immediately from the second closed loop 68 at an outboard distal end 72, and terminates at a proximal end 74 which is a terminal free end of the second outboard layer 66. Compared to the second inboard layer 64, the second outboard layer 66 has a greater radial length and extent.

A second aperture 76 is defined in the second flange 34 and through the second inboard and outboard layers 64, 66. The second aperture 76 receives insertion of the bolt of the tightening mechanism 24. As perhaps shown best in FIG. 6, the second aperture 76 has a circular shape, matching a circular shape of a section of the bolt that is inserted in the second aperture 76. In other embodiments, the second aperture 76 could have a non-circular shape like that described for the first aperture 56. The second closed loop 68 is situated at the distal ends 70, 72 of the second inboard and outboard layers 64, 66, and is defined at the vertex of the folded sheet of metal material. The second closed loop 68 resides inboard with respect to the second inboard and outboard layers 64, 66. An inboard-directed surface 78 of the second closed loop 68 constitutes the most inboardly-directed section of the second flange 34 relative to its other sections—in other words, a bight in the loop of the second closed loop 68 faces inwardly.

Still, in other embodiments not presented in the figures, the second flange 34 could have other designs and constructions. For instance, the second flange 34 could be made by folding the sheet of metal material back onto itself in an inboard direction D (inboard direction D is defined with respect to the second flange 34).

Referring now to FIGS. 4, 7, and 8, the tightening mechanism 24 is placed at the first and second flanges 32, 34 and is actuated to cause radial contraction and expansion of the band 22 for tightening and loosening the band clamp 16. In this embodiment, the tightening mechanism 24 includes a single bolt 80, a single nut 82, and a single washer 84. The single bolt 80 could be a carriage bolt of the size M8; of course, other types and sizes of bolts are possible. The single bolt 80 has a head 86 and a shank 88. The head 86 has a working surface 90 on its inner side that, in assembly, directly engages and abuts a first outer surface 92 of the first outboard layer 46. The shank 88 is inserted into and disposed through the first and second apertures 56, 76. Threads are provided on a section or more of the shank 88 for screwing the single nut 82 thereon amid rundown. As set forth above, a section 94 of the shank 88 can have a non-circular shape and cross-sectional profile to match that of the first aperture 56. The single nut 82 is screwed on and carried by the shank 88 of the single bolt 80. The single nut 82 can be a flange nut, or another type of nut. The single washer 84 is set on and carried by the shank 88 at an axial position (“axial” used here with respect to the generally cylindrical shank) between the single nut 82 and the second flange 34—in other words, the single washer 84 is sandwiched between the single nut 82 and the second flange 34. The single washer 84 has a working surface 96 on its inner side that, in assembly, directly engages and abuts a second outer surface 98 of the second outboard layer 66. Still, in other embodiments not presented in the figures, the tightening mechanism 24 could have other designs, constructions, and components. For instance, additional washers could be incorporated into the tightening mechanism 24, such as between the head 86 and the first flange 32.

As described, the band clamp 16 is composed of four constituent parts: the band 22, the single bolt 80, the single nut 82, and the single washer 84. This minimized part count provides a lighter weight band clamp, and one that is more readily assembled, installed, and serviced in application compared to clamps with a greater number of components. Unlike previous band clamps for telescopically overlapping pipe end configurations, the band clamp 16 lacks a reaction member. And unlike previous pipe couplers for end-to-end abutting pipe end configurations, the band clamp 16 lacks a pair of bolts and a pair of accompanying nuts, and lacks a split sealing sleeve. These additional components, while conventional in their respective applications, were found unnecessary in the embodiments of the band clamp 16 presented herein.

In use, the band clamp 16 is tightened over the male and female pipe ends 12, 14 to provide an effective fluid-tight seal and an effective retention at the established joint. Prior to rundown, the band clamp 16 is somewhat loosely assembled about the male and female pipe ends 12, 14, as depicted in FIG. 4. This constitutes a first and initial state of installation. The first and second flanges 32, 34 are spaced apart from each other by a gap, with the shortest distance therebetween measured between the inboard-directed surfaces 58, 78. In this state, the first and second flanges 32, 34 exhibit a generally geometrically straight configuration, as illustrated in FIG. 4, and lack deformation from the tightening mechanism 24. Here too, the first and second ends 28, 30 are separated from each other by a circumferential gap 100. As rundown initiates and the single nut 82 is torqued-down over the single bolt 80, the first and second flanges 32, 34 are brought toward each other, as depicted in FIG. 9. This constitutes a second and intermediate state of installation. The first and second closed loops 48, 68 come into initial contact between the first and second flanges 32, 34 at the inboard-directed surfaces 58, 78—other portions of the flanges 32, 34 remain without contact. In the intermediate state, as in the previous initial state, the first and second flanges 32, 34 exhibit their un-deformed geometrically-straight configuration. Here, the first and second ends 28, 30 are pulled and drawn toward each other from their previous position, but still are separated by the circumferential gap 100. Compared to the previous initial state, the circumferential gap 100 has closed, and has a decreased distance in this intermediate state.

Upon further rundown, the first and second closed loops 48, 68 serve as a fulcrum about which the inboard and outboard layers 44, 46, 64, 66 of the first and second flanges 32, 34 are urged to turn and deform into a first bow-shaped deformation 102 and a second bow-shaped deformation 104, as depicted in FIG. 10. This constitutes a third and final state of installation. Engagement between the head 86 and the first flange 32 causes the effectuation of the first bow-shaped deformation 102 and, likewise, engagement between the single washer 84 and the second flange 34 causes the effectuation of the second bow-shaped deformation 104. Due to the torque applied from rundown, the first and second closed loops 48, 68 can be slightly deformed themselves and set back a bit from their previous position relative to the respective inboard and outboard layers 44, 46, 64, 66 as they yield to the applied torque. The first and second inboard layers 44, 64 can make line and/or surface contact at first and second inner surfaces 106, 108 thereof, though need not, in the final state. Here, the first and second ends 28, 30 are further pulled and drawn toward each other from their previous positions. The circumferential gap 100 has closed yet more, and has a decreased distance in this final state compared to the previous intermediate state.

The first and second bow-shaped deformations 102, 104 can generally correspond with each other in terms of size, shape, and magnitude (“generally correspond,” and its grammatical variations, is intended to account for the inherent degree of imperfection and imprecision accompanying such deformation actions, which could be due to imperfections and imprecisions in manufacturing and metalworking processes). The first and second flanges 32, 34 can undergo a similar rate of deformation from the geometrically-straight configurations to the first and second bow-shaped deformations 102, 104. In some embodiments, corresponding and similar actions of deformation at the first and second flanges 32, 34, as described, has been shown to properly pull and draw the first and second ends 28, 30 toward each other and decrease the circumferential gap 100. This, in turn, precludes a pucker-like deformation in the female pipe end 14, and helps ensure an effective fluid-tight seal and an effective retention at the established joint. It has been found that, in some embodiments, dimensional aspects of the working surfaces 90, 96 can impact the deformation actions of the first and second flanges 32, 34. For example, when the working surfaces 90, 96 have substantially similar diameters, corresponding and similar actions of deformation at the first and second flanges 32, 34 can more readily be carried out (“substantially similar,” and its grammatical variations, is intended to account for an acceptable amount of dissimilarity such that exactness is not demanded). In another example, when the working surfaces 90, 96 establish substantially similar areas of engagement with respective first and second outer surfaces 92, 98, corresponding and similar actions of deformation at the first and second flanges 32, 34 can more readily be carried out. The areas of engagement are the areas of direct surface-to-surface engagement and abutment made between the respective surfaces.

Since, in this overlapping pipe end configuration, the applied clamping load upon rundown acts directly on the female pipe end 14—and not on a split sealing sleeve in end-to-end abutting pipe end configurations—a greater magnitude of clamping load is called for. It has been found that greater magnitudes of clamping load may improperly deform the first and second flanges 32, 34 and may not properly pull and draw the first and second ends 28, 30 toward each other. A pucker-like deformation in the female pipe end 14 might develop. Consequently, an effective fluid-tight seal and an effective retention may not be established at the joint. To resolve these drawbacks, a stiffening means 110 has been incorporated into the design and construction of the band clamp 16. The stiffening means 110 works to impart strength and stiffness in the rundown action at the first flange 32, at the second flange 34, or at both the first and second flanges 32, 34. The imparted strength and stiffness has been shown to properly pull and draw the first and second ends 28, 30 toward each other and decrease the circumferential gap 100. This, in turn, precludes a pucker-like deformation in the female pipe end 14, and helps ensure an effective fluid-tight seal and an effective retention at the established joint. The stiffening means 110 can be provided in different forms in different embodiments. In the embodiment of FIGS. 1-10, the stiffening means 110 is provided in the form of the washer 84. At its example location sandwiched between the single nut 82 and the second flange 34, the washer 84 imparts strength and stiffness to the second flange 34. The imparted strength and stiffness may be commensurate with that imparted to the first flange 32 via the head 86.

In another embodiment of FIG. 11, a stiffening means 210 is provided in the form of multiple ribs residing in the first flange 32 and in the second flange 34. Here, the first flange 32 has a first rib 211 and has a second rib 213, and the second flange 34 has a third rib 215 and has a fourth rib 217. The ribs 211, 213, 215, 217 can be formed in their respective flange via a suitable metalworking process such as a stamping process. The ribs 211, 213, 215, 217 span axially across the respective first and second flanges 32, 34. The first rib 211 resides at a radially upward end of the first flange 32, and the second rib 213 resides at a radially downward end of the first flange 32. Likewise, the third rib 215 resides at a radially upward end of the second flange 34, and the fourth rib 217 resides at a radially downward end of the second flange 34. In alternatives to this embodiment, the ribs could be provided in different quantities and in different arrangements in the first flange 32, in the second flange 34, or in both of the first and second flanges 32, 34. As one alternative, a single rib could be provided elsewhere in the first flange 32, while the second flange 34 can lack ribs altogether. The embodiment of FIG. 11 can lack the single washer of the previous embodiment of FIGS. 1-10.

In yet another embodiment of FIGS. 12 and 13, a stiffening means 310 is provided in the form of an embossment 319 residing in the second flange 34. Here, the embossment 319 is a single embossment that can be formed in the second flange 34 via a suitable metalworking process such as a stamping process. The embossment 319 has a ring-like shape that encircles the single nut 82. In alternatives to this embodiment, the embossment could be provided in different quantities and in different arrangements in the first flange 32, in the second flange 34, or in both of the first and second flanges 32, 34. As one alternative, a second embossment could be provided in the second flange 34 in addition to the embossment 319. The embodiment of FIGS. 12 and 13 can lack the single washer of the previous embodiment of FIGS. 1-10.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Furthermore, recitations of “at least one” component, element, or the like should not be used to create an inference that the alternative use of the articles “a” or “an” should be limited to the singular. Other terms are to be construed using their broadest reasonable meaning unless they are used in a context that requires a different interpretation.

1. A band clamp for securing overlapping pipe ends, the band clamp comprising:
a band of sheet metal spanning circumferentially from a first end to a second end, said band having a first flange extending radially from said first end and having a second flange extending radially from said second end, said first flange having a first inboard layer of sheet metal and a first outboard layer of sheet metal, said first inboard and outboard layers making surface-to-surface abutment, said first flange having a first closed loop at distal ends of said first inboard layer and said first outboard layer, said first flange having a first aperture residing in said first inboard layer and in said first outboard layer at the surface-to-surface abutment therebetween, said second flange having a second inboard layer of sheet metal and a second outboard layer of sheet metal, said second inboard and outboard layers making surface-to-surface abutment, said second flange having a second closed loop at distal ends of said second inboard layer and said second outboard layer, said second flange having a second aperture residing in said second inboard layer and in said second outboard layer at the surface-to-surface abutment therebetween; and
a tightening mechanism to tighten the band clamp over the overlapping pipe ends, said tightening mechanism including a single bolt, a single nut, and a washer, said single bolt having a head and a shank, said head engaging said first flange, said shank disposed through said first and second apertures and being at least partially threaded, said single nut carried by said shank, said washer carried by said shank between said single nut and said second flange and engaging said second flange;
wherein, upon tightening of the band clamp over the overlapping pipe ends, said single nut is rundown on said single bolt and said first and second flanges are brought toward each other with said first and second closed loops making initial contact between said first and second flanges and causing said first and second ends of said band to be drawn toward each other, engagement between said head and said first flange effecting a first bow-shaped deformation in said first flange at the surface-to-surface abutment between said first inboard and outboard layers, and engagement between said washer and said second flange effecting a second bow-shaped deformation in said second flange at the surface-to-surface abutment between said second inboard and outboard layers.

2. The band clamp set forth in claim 1, wherein said first closed loop is formed by folding the sheet metal of said first inboard layer and first outboard layer back onto itself in an outboard direction with said first closed loop defined by the folded sheet metal, and wherein said second closed loop is formed by folding the sheet metal of said second inboard layer and second outboard layer back onto itself in an outboard direction with said second closed loop defined by the folded sheet metal.

3. The band clamp as set forth in claim 1, wherein said first aperture of said first flange has a non-circular shape and at least the section of said shank disposed through said first aperture has a non-circular shape generally matching the non-circular shape of said first aperture, and wherein, upon rundown of said single nut on said single bolt, the non-circular shapes of said first aperture and said shank preclude said single bolt from spinning concurrently with said single nut.

4. The band clamp set forth in claim 1, wherein said head has a first working surface that directly engages a first outer surface of said first outboard layer of said first flange, and said washer has a second working surface that directly engages a second outer surface of said second outboard layer of said second flange.

5. The band clamp set forth in claim 4, wherein a first diameter of said first working surface of said head is substantially similar to a second diameter of said second working surface of said washer in order to facilitate effectuating a generally corresponding first and second bow-shaped deformation upon rundown of said single nut on said single bolt.

6. The band clamp set forth in claim 4, wherein a first area of engagement established between said first working surface of said head and said first outer surface of said first outboard layer is substantially similar to a second area of engagement established between said second working surface of said washer and said second outer surface of said second outboard layer in order to facilitate effectuating a generally corresponding first and second bow-shaped deformation upon rundown of said single nut on said single bolt.

7. The band clamp set forth in claim 1, wherein said first bow-shaped deformation and said second bow-shaped deformation generally correspond to each other.

8. The band clamp set forth in claim 1, wherein, prior to rundown of said single nut on said single bolt, said first and second flanges are situated spaced apart from each other with a first gap defined therebetween and each of said first and second flanges exhibits a generally geometrically straight configuration, and, as rundown of said single nut on said single bolt proceeds prior to initial contact between said first and second closed loops, said first and second flanges generally maintain their geometrically straight configuration and said first and second ends of said band are drawn together and a second gap defined therebetween closes.

9. The band clamp set forth in claim 1, wherein the band clamp lacks a sleeve, and said tightening mechanism lacks a second bolt and lacks a second nut.

10. A pipe lap joint comprising a male pipe end and a female pipe end, and comprising the band clamp of claim 1.

11. The pipe lap joint set forth in claim 10, wherein said female pipe end has at least one collapsible sealing slot residing therein.

12. A band clamp for securing overlapping pipe ends, the band clamp comprising:
a band of sheet metal spanning circumferentially from a first end to a second end, said band having a first flange extending radially from said first end and having a second flange extending radially from said second end, said first flange having a first inboard layer of sheet metal and a first outboard layer of sheet metal, said first inboard and outboard layers making surface-to-surface abutment, said first flange having a first closed loop at distal ends of said first inboard layer and said first outboard layer, said first flange having a first aperture residing in said first inboard layer and in said first outboard layer at the surface-to-surface abutment therebetween, said second flange having a second inboard layer of sheet metal and a second outboard layer of sheet metal, said second inboard and outboard layers making surface-to-surface abutment, said second flange having a second closed loop at distal ends of said second inboard layer and said second outboard layer, said second flange having a second aperture residing in said second inboard layer and in said second outboard layer at the surface-to-surface abutment therebetween;
a tightening mechanism to tighten the band clamp over the overlapping pipe ends, said tightening mechanism including a single bolt and a single nut, said single bolt disposed in said first and second apertures of said first and second flanges; and
a stiffening means applied to said first flange, to said second flange, or to both of said first and second flanges, in order to impart stiffness thereto;
wherein, upon initial rundown of said single nut on said single bolt, said first and second flanges are brought toward each other and said first and second ends of said band are drawn toward each other to close a gap defined therebetween by a first distance, and wherein, upon further rundown of said single nut on said single bolt, said first and second closed loops make contact and said first flange deforms into a first bow-shape and said second flange deforms into a second bow-shape and said first and second ends of said band are drawn toward each other to close said gap by a second distance, said stiffening means facilitating closing of said gap by said first distance and by said second distance.

13. The band clamp set forth in claim 12, wherein said stiffening means is effected via a washer of said tightening mechanism carried by said single bolt and engaging said second flange amid rundown of said single nut on said single bolt.

14. The band clamp set forth in claim 12, wherein said stiffening means is effected via at least one rib residing in said first flange, in said second flange, or in both of said first and second flanges.

15. The band clamp set forth in claim 12, wherein said stiffening means is effected via at least one embossment residing in said first flange, in said second flange, or in both of said first and second flanges.
